(19) United States
(12) Patent Application Publication
(10) Pub. No.: US 2008/0123367 A1
(43) Pub. Date: May 29, 2008

(54) Light source unit for use in a backlight module

(75) Inventors: Chang-Hung Pan, Taipei (TW); Chen-Hua Huang, Taipei (TW)

Correspondence Address: BIRCH STEWART KOLASCH & BIRCH, PO BOX 747, FALLS CHURCH, VA, 22040-0747, US

(73) Assignee: Lite-On Technology Corp.

(21) Appl. No.: 11/797,299

(22) Filed: May 2, 2007

(30) Foreign Application Priority Data
Nov. 23, 2006 (TW) 095143374

(51) Int. Cl. F21V 8/00

(52) U.S. Cl. 362/628; 362/615; 362/631

(57) ABSTRACT

A light source unit for use in a backlight module includes a circuit substrate board and a plurality of chip assemblies arranged along a first direction of the circuit substrate board. Each of the chip assemblies includes a red LED chip, a blue LED chip, and a green LED chip. By employing a chip on board (COB) concept, and by providing LED chips of three primary colors directly on the circuit substrate board, chip spacing can be considerably reduced to effectively shorten the light mixing distance so as to permit miniaturization of the backlight module incorporating the light source unit.

### CROSS-REFERENCE TO RELATED APPLICATION

This application claims priority of Taiwanese Application No. 095143374, filed on Nov. 23, 2006.

### BACKGROUND OF THE INVENTION

1. Field of the Invention

The invention relates to a light source unit for use in a backlight module, more particularly to a light source unit capable of shortening a light mixing distance to permit miniaturization of a backlight module incorporating the same.

2. Description of the Related Art

With the continuous trend toward miniaturization of liquid crystal display modules, backlight modules that provide planar light sources for liquid crystal display modules need to be improved in order to conform to the current trend.

Due to color rendering performance and environmental concerns, conventional backlight modules that employ cold cathode fluorescent lamps (CCFL) have been gradually replaced by light emitting diodes (LED) that have better color rendering properties and that do not contain mercury.

Referring to FIG. 1, a conventional direct bottom type backlight module 10 which adopts light emitting diodes as light sources includes a light guide plate 11 and a plurality of light source units 12. The light guide plate 11 has a light exiting side 111 and a light entering side 112 opposite to the light exiting side 111.

As shown in FIG. 2, each of the light source units 12 includes a circuit substrate board 121 and a plurality of light emitting diodes 122 provided on the circuit substrate board 121. In addition, the light emitting diodes 122 are arranged in order of colors, i.e., red (R), blue (B) and green (G), on the circuit substrate board 121 along a long-axis direction of the circuit substrate board 121, and are connected electrically to the circuit substrate board 121 such that the three colors of light blend into white light.

Each of the light emitting diodes 122 is an LED package which includes an LED chip 123 for emitting a corresponding color of light, a package base 124 for carrying the LED chip 123 and supplying power to the LED chip 123, and a lens 125 for guiding the light emitted by the LED chip 123.

As shown in FIG. 3, since the light emitted by the light emitting diodes 122 has a light dispersion angle θ, the three colors of light emitted by the light emitting diodes 122 that are disposed along the long-axis direction of the circuit substrate board 121 will have to go through a light mixing distance (d1) that is normal to the light emitting diodes 122 such that the light dispersion angles of the three colors of light overlap in order to blend the colored lights into white light.

Therefore, the distance between the light entering side 112 and the light source unit 12 is at least greater than the light mixing distance (d1), so that the light emitted by the light emitting diodes 122 is properly mixed into white light before entering into the light guide plate 11 through the light entering side 112, thereby preventing color inconsistency of light radiating from the light exiting side 111.

At a specific light dispersion angle θ, the light mixing distance (d1) is indirect proportion to a spacing or distance (d2) between two adjacent LED chips. In other words, the smaller the distance (d2), the shorter the required light mixing distance (d1) would become. A shorter required light mixing distance (d1) permits a reduction in the distance between the light entering side 112 of the light guide plate 11 and the light source unit 12, so that the backlight module 10 can be made into a more compact size.

However, as mentioned above, packaged light emitting diodes 122 are used for the light source unit 12. Further shortening of the chip spacing or distance (d2) may not be feasible due to the fixed size of the package base 124. As a result, the light mixing distance (d1) cannot be reduced, which in turn renders shortening of the distance between the light entering side 112 of the light guide plate 11 and the light source unit 12 difficult. Hence, the conventional backlight module 10 cannot be miniaturized further.

### SUMMARY OF THE INVENTION

Therefore, an object of the present invention is to provide a light source unit for use in a backlight module, which permits miniaturization of the backlight module by shortening a light mixing distance.

Another object of the present invention is to provide a light source unit for use in a backlight module, which can guide light in a predetermined direction.

A further object of the present invention is to provide a light source unit for use in a backlight module, which can improve light mixing effects.

Accordingly, the light source unit of the present invention employs a chip on board (COB) concept, and has LED chips of three primary colors arranged directly on a circuit substrate board such that a spacing between adjacent chips can be considerably reduced to effectively shorten a light mixing distance so as to permit miniaturization of the backlight module incorporating the light source unit.

Furthermore, in the present invention, the LED chips of three primary colors are arranged along a predetermined direction and then encapsulated. During encapsulation, a mold is used to form two different encapsulating top faces that can guide the light emitted from the LED chips toward the top for convergence or to the sides.

Thus, the present invention which provides two different forms of encapsulating top faces to guide light can be applied to a direct bottom type backlight module or a side light type backlight module.

In addition, the LED chips of three primary colors are arranged on the circuit substrate board according to predetermined arrangements, which include straight, staggered and matrix arrangements, so as to improve the light mixing effect.

Accordingly, the light source unit for use in a backlight module of the present invention includes a circuit substrate board and a plurality of chip assemblies. The circuit substrate board has a top face and a bottom face, and defines a first direction parallel to the top and bottom faces. The chip assemblies are disposed directly on the top face of the circuit substrate board along the first direction, and are connected electrically to the circuit substrate board. Each of the chip assemblies includes a red LED chip, a blue LED chip, and a green LED chip.

In the light source unit for use in a backlight module of the present invention, the LED chips are disposed directly on and are connected electrically to the circuit substrate board, thereby eliminating the use of package bases for carrying LED chips in the prior art. Thus, the LED chips can be arranged in a denser manner on the circuit substrate board to considerably reduce the chip spacing, thereby shortening the light mixing distance.

Since the light source unit of the present invention has the advantage of shortening the light mixing distance, replacing the conventional light source unit with the light source unit of the present invention in a backlight module can reduce the overall size of the backlight module.

Accordingly, a direct bottom type backlight module that incorporates the light source unit of this invention includes a transparent light guide plate and a light source unit. The transparent light guide plate has a light exiting side and a light entering side opposite to the light exiting side. The light source unit includes a circuit substrate board and a plurality of chip assemblies. The circuit substrate board has a top face and a bottom face, and defines a first direction parallel to the top and bottom faces. The chip assemblies are arranged directly on the top face of the circuit substrate board along the first direction, and are connected electrically to the circuit substrate board. Each of the chip assemblies includes a red LED chip, a blue LED chip, and a green LED chip.

Since the light source unit of this invention has the advantage of shortening the light mixing distance, when applied to the direct bottom type backlight module, a distance from the light entering side of the light guide plate to the light source unit can be shortened to permit miniaturization of the direct bottom type backlight module.

Accordingly, a side light type backlight module incorporating the light source unit of this invention includes a transparent light guide plate and a light source unit. The transparent light guide plate has a light exiting side and a light entering side adjoining the light exiting side. The light source unit includes a circuit substrate board and a plurality of chip assemblies. The circuit substrate board has a top face and a bottom face, and defines a first direction parallel to the top and bottom faces. The chip assemblies are arranged directly on the top face of the circuit substrate board along the first direction, and are connected electrically to the circuit substrate board. Each of the chip assemblies includes a red LED chip, a blue LED chip, and a green LED chip.

Since the light source unit of this invention has the advantage of shortening the light mixing distance, when applied to the side light type backlight module, a distance from the light entering side of the light guide plate to the light source unit can be shortened to permit miniaturization of the side light type backlight module.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic perspective view of a conventional backlight module;

FIG. 2 is a fragmentary schematic perspective view of a light source unit of the conventional backlight module;

FIG. 3 is a schematic view to illustrate the relationship between chip spacing and light mixing distance in the conventional backlight module;

FIG. 4 is a fragmentary schematic perspective view of the preferred embodiment of a light source unit according to this invention;

FIG. 5 is a fragmentary schematic perspective view to illustrate a side light guiding type encapsulating member of the preferred embodiment;

FIG. 6 is a schematic side view showing the encapsulating member of FIG. 5;

FIG. 7 is a fragmentary schematic perspective view to illustrate a top face light converging type encapsulating member of the preferred embodiment;

FIG. 8 is a schematic side view showing the encapsulating member of FIG. 7;

FIG. 9 is a fragmentary schematic perspective view of the preferred embodiment to illustrate a straight arrangement of LED chips of three different colors;

FIG. 10 is a fragmentary schematic perspective view of the preferred embodiment to illustrate a staggered arrangement of the LED chips of three different colors;

FIG. 11 is a fragmentary schematic perspective view of the preferred embodiment to illustrate a matrix arrangement of the LED chips of three different colors;

FIG. 12 is a schematic view of the preferred embodiment when incorporated in a direct bottom type backlight module;

FIG. 13 is a schematic view of the preferred embodiment when incorporated in a side light type backlight module; and

FIG. 14 is a schematic view of the preferred embodiment when incorporated in another side light type backlight module.

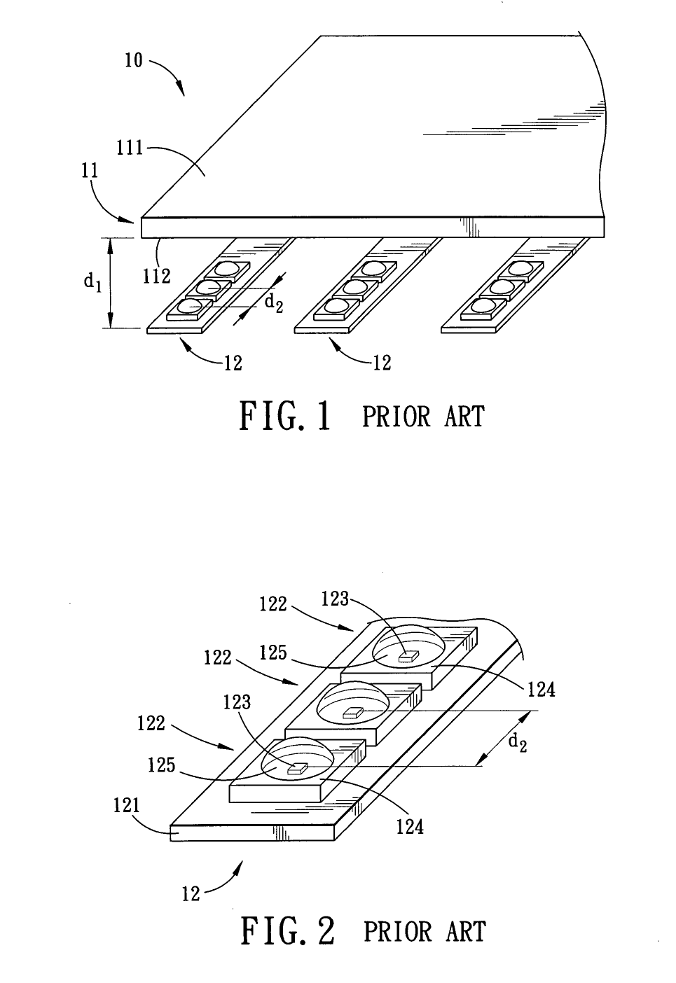

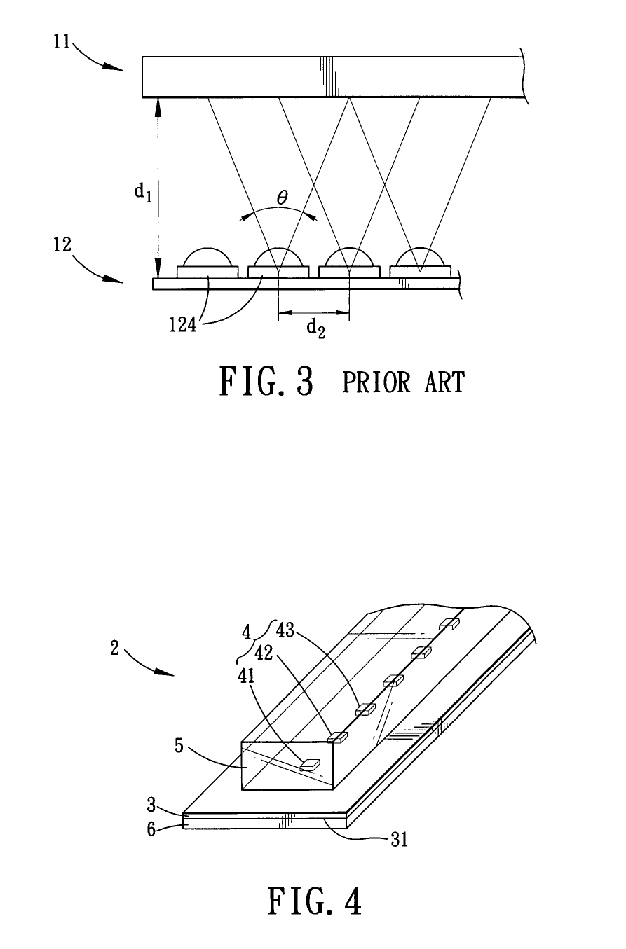

### DETAILED DESCRIPTION OF THE PREFERRED EMBODIMENT

With reference to FIG. 4, the preferred embodiment of a light source unit 2 according to the present invention is adapted for use in a backlight module, and includes a circuit substrate board 3, a plurality of LED chip assemblies 4 provided on the circuit substrate board 3, an encapsulating member 5 for encapsulating the chip assemblies 4, and a heat dissipating member 6 disposed on a bottom face 31 of the circuit substrate board 3.

The circuit substrate board 3 is an elongated strip of printed circuit board (PCB), and is formed with a circuit pattern using micro-lithography. Aside from using a rigid printed circuit board, a flexible circuit board or a composite circuit board can also be used for the circuit board substrate 3.

The chip assemblies 4 are arranged along a first direction of the circuit substrate board 3. In this embodiment, the chip assemblies 4 are arranged linearly and directly on a top face of the circuit substrate board 3 along a long-axis direction of the circuit substrate board 3. Each chip assembly 4 includes a red (R) LED chip 41, a green (G) LED chip 42, and a blue (B) LED chip 43. The number of chip assemblies 4 depends on design requirements.

Each of the LED chips 41, 42, 43 includes two electrodes (not shown). The electrodes are connected electrically to the circuit substrate board 3 with one electrode connected to the circuit substrate board 3 by wire bonding, and the other electrode directly bonded to the circuit substrate board 3. Alternatively, flip chip bonding can be used to connect electrically the LED chips 41, 42, 43 to the circuit substrate board 3.

The encapsulating member 5 extends along the long-axis direction of the circuit substrate board 3 to encapsulate all of the LED chips 41, 42, 43 so as to isolate the LED chips 41, 42, 43 from the outside air, thereby preventing oxidation of the LED chips 41, 42, 43 and associated metallic members, and thus electrical degradation or failure. The encapsulating member 5 is formed from transparent epoxy resin, and maybe formed using a mold forming method, in which epoxy resin material is poured into a mold cavity of a mold to directly form an elongated strip encapsulating the chips 41, 42, 43 on the circuit substrate board 3. Compared with the aforementioned prior art in which the LED chips are individually packaged and the packaged chips are placed on the circuit substrate board, the encapsulating member 5 of the light source unit 2 according to the present invention is formed to encapsulate all of the chips 41, 42, 43 on the circuit substrate board 3 in one operation. Thus, the manufacturing process can be simplified, and manufacturing costs can be reduced.

In addition, as a large amount of heat is generated when the LED chips 41, 42, 43 are activated to generate light, the heat has to be dissipated so as not to affect the lighting efficiency of the LED chips 41, 42, 43. The heat dissipating member 6 is provided on the bottom face 31 of the circuit substrate board 3 to assist in heat dissipation. The heat dissipating member 6 is shaped to match the circuit substrate board 3. In general, the heat dissipating member 6 is formed from a metal with good thermal conductivity, such as copper or aluminum.

In comparison with the prior art in which the red, blue and green LEDs of the light source unit are individually packaged before being disposed on the circuit substrate board, the present invention, in which the LED chips 41, 42, 43 of the light source unit 2 are directly disposed on and electrically connected to the circuit substrate board 3, can dispense with the package bases used for carrying the LED chips in the prior art, and allows for a denser arrangement of the LED chips 41, 42, 43 on the circuit substrate board 3, thereby considerably reducing the chip spacing to effectively shorten the light mixing distance.

The light source unit 2 of the present invention further has a light guiding structure formed on the encapsulating member 5 to meet the current requirements of a backlight module. Two different forms of the encapsulating member 5 will be described hereinbelow in terms of the form of light guiding structure and the corresponding effect achievable thereby.

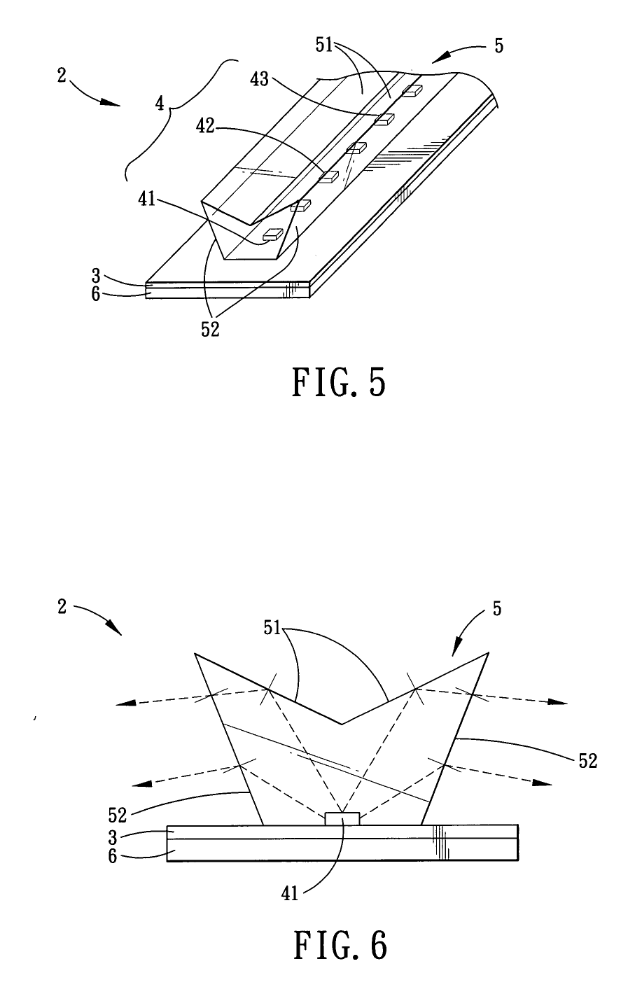

Referring to FIGS. 5 and 6, the encapsulating member 5 has a substantially V-shaped cross-section. Specifically, the encapsulating member 5 has a V-shaped top face and upright lateral side faces 52. The V-shaped top face includes a pair of light guiding faces 51 that slope toward each other and that extend along the long-axis direction of the circuit substrate board 3. Light emitted from the LED chips 41, 42, 43 is substantially guided by the light guiding faces 51 to be reflected to the outside through the lateral side faces 52 that also extend along the long-axis direction of the circuit substrate board 3.

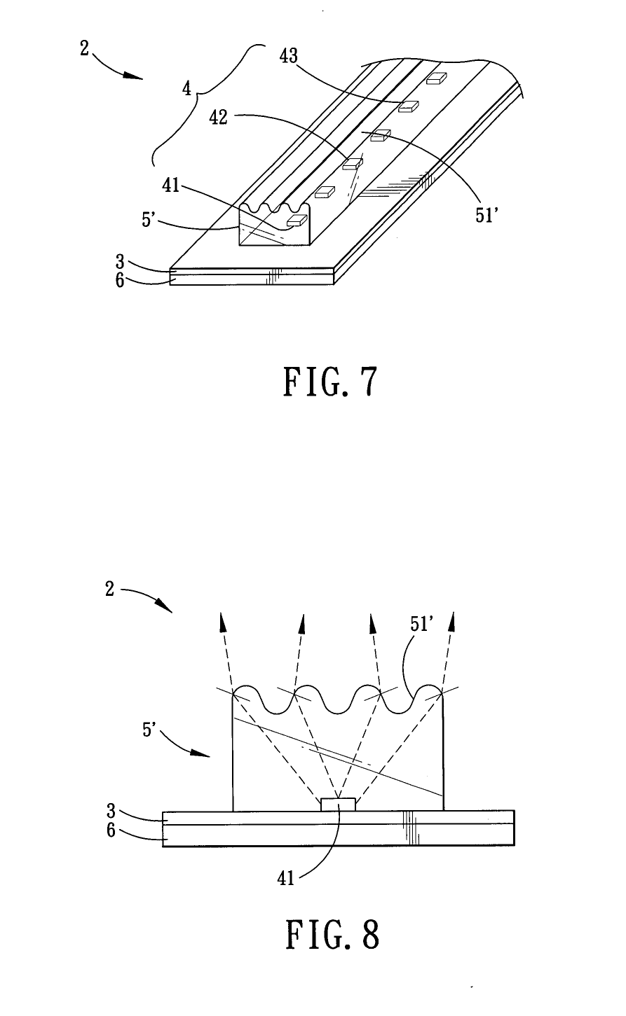

Referring to FIGS. 7 and 8, the top face of the encapsulating member 5′ is formed with a corrugated light guiding face 51′ that extends in the long-axis direction of the circuit substrate board 3. Due to the configuration of the corrugated light guiding face 51′, the light of the LED chips 41, 42, 43 exiting the corrugated light guiding face 51′ can be relatively converged and focused. In practice, the light guiding face 51′ can be formed into a serrated face to achieve the same effect.

Apart from providing the LED chips 41, 42, 43 directly on the circuit substrate board 3 to shorten the light mixing distance, the light mixing effect can be enhanced through arrangement of the LED chips 41, 42, 43 of three different colors on the top side of the circuit substrate board 3. The arrangements of the LED chips 41, 42, 43 of three different colors in the chip assembly 4 are described as follows.

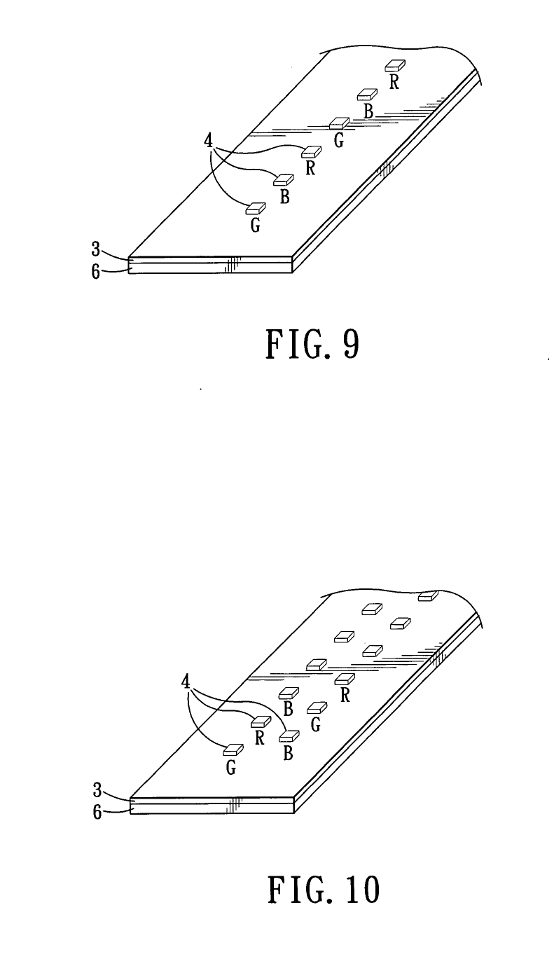

Referring to FIG. 9, chip assemblies 4 each including three LED chips are arrayed in a straight line along the long-axis direction of the circuit substrate board 3, with a color sequence of green (G), blue (B), and red (R). Alternatively, the LED chips can be arranged in the sequence: green (G), red (R), and blue (B). Certainly, other color sequences, such as BRG, RGB, RBG, etc., are also equivalent to the two color sequences given above. Take two chip assemblies 4 as an example of the GBR color sequence. The LED chips are arranged in the sequence: GBRGBR. It will be apparent that this color sequence includes three equivalent color sequences of GBR (the first to third chips), BRG (the second to fourth chips), and RGB (the third to fifth chips). Similarly, the GBR color sequence also includes three equivalent color sequences.

Referring to FIG. 10, chip assemblies 4 each including LED chips of three different colors are arranged in two arrays along the long-axis direction of the circuit substrate board 3, with the LED chips arranged in the sequence of green (G), blue (B), and red (R). The three LED chips are not arranged in a straight line, but are arranged in the staggered pattern as shown in the figure. Alternatively, the LED chips can be arranged in the sequence of green (G), red (R), and blue (B).

In other words, the nth odd or even numbers of the LED chips of FIG. 9 are moved the same distance in the same direction along a short-axis direction of the circuit substrate board 3 to form another array such that the distance between the odd or even numbered LED chips in the chip assemblies 4 is shortened relatively to thereby shorten the light mixing distance.

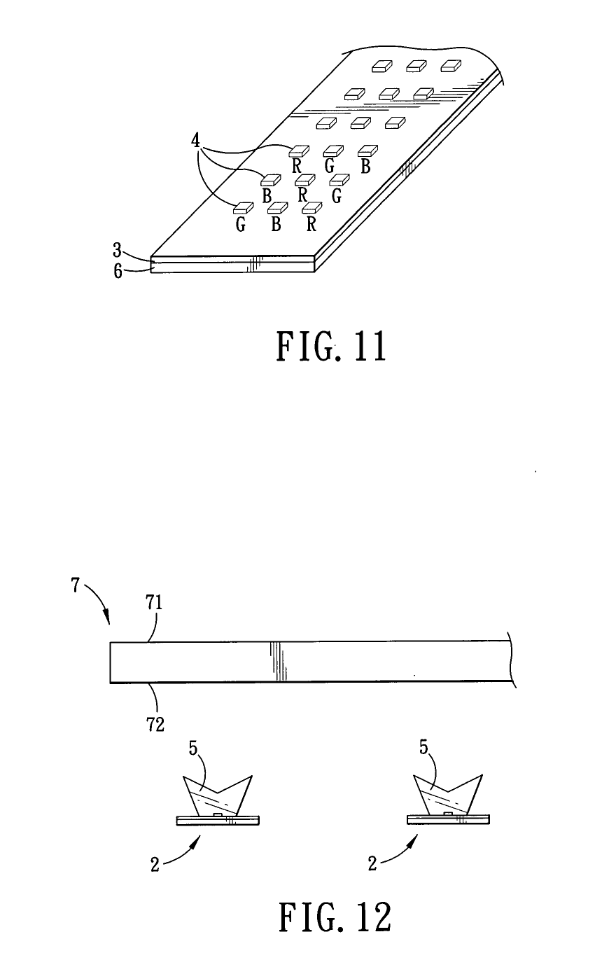

As shown in FIG. 11, chip assemblies 4 each including three LED chips of different colors are arranged in a matrix, and the LED chips are arranged along a short-axis direction of the circuit substrate board 3. In the figure, the LED chips in the leftmost array along the long-axis direction of the circuit substrate board 3 and the LED chips in the lower array along the short-axis direction are arranged in the color sequence of GBR. The color sequence may also be GRB in other embodiments of this invention.

In other words, the arrangement of the LED chips along the long-axis direction of the circuit substrate board 3 follows the color sequence of GBR, whereas the LED chips along the short-axis direction of the circuit substrate board 3 are of three different colors.

Since the light source unit 2 of the present invention has the advantage of shortening the light mixing distance, when used in place of the conventional light source unit in a backlight module, the size of the entire backlight module can be minimized. Hereinbelow, the light source unit 2 of the present invention will be discussed in the scenarios where it is incorporated in a conventional direct bottom type backlight module and a conventional side light type backlight module.

Referring to FIG. 12, the light source unit 2 is applied to a direct bottom type backlight module that includes a light guide plate 7 in the form of a transparent rectangular plate, and a plurality of the light source units 2 having an encapsulating member 5 of the side light guiding type shown in FIG. 6.

The light guide plate 7 has a light exiting side 71 and a light entering side 72 opposite to the light exiting side 71. The light source units 2 are disposed to below the light entering side 72 of the light guide plate 7. Application of the light source unit 2 of this invention to a backlight module works in two different modes, as detailed below. The two aforesaid forms of light source unit 2 that have encapsulating members 5, 5′ with different light guiding structures are respectively applied in these modes.

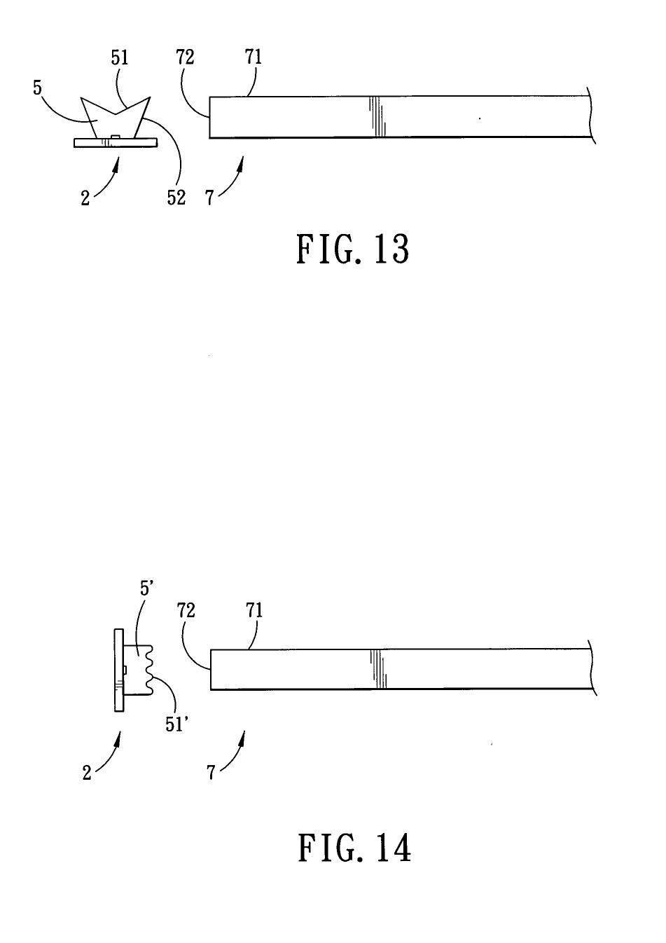

Reference is made to FIG. 13, which schematically shows that the light source unit 2 having a lateral side light guiding type encapsulating member 5 of FIG. 6 is applied to a side light type backlight module. The backlight module includes a light guide plate 7 in the form of a flat transparent rectangular plate, and the light source unit 2 as shown in FIG. 6.

The light guide plate 7 has a light exiting side 71 and a light entering side 72 adjoined perpendicularly to the light exiting side 71. The light source unit 2 is disposed at the light entering side 72 of the light guide plate 7, with the lateral side face 52 of the encapsulating member 5 substantially confronting the light entering side 72 such that light emitted from the LED chips 41, 42, 43 and guided toward the lateral sides due to the configuration of the lateral side light guiding type encapsulating member 5 irradiates toward the light entering side 72 of the light guide plate 7.

Since the light source unit 2 of this invention has the advantage of shortening the light mixing distance, when used in a backlight module in practice, the distance from the light entering side 72 of the light guide plate 7 to the light source unit 2 can be shortened, thereby permitting a more compact design of the entire side light type backlight module.

Reference is made to FIG. 14, which schematically shows that the light source unit 2 having the top face light converging type encapsulating member 5′ of FIG. 8 is applied to a side light type backlight module. The backlight module includes a light guide plate 7 in the form of a flat transparent rectangular plate, and the light source unit 2 as shown in FIG. 8.

The light guide plate 7 has a light exiting side 71 and a light entering side 72 adjoined perpendicularly to the light exiting side 71. The corrugated light guiding face 51′ at the top of the encapsulating member 5′ of the light source unit 2 is disposed to confront the light entering side 72 such that light emitted from the LED chips 41, 42, 43 and guided by the encapsulating member 5′ irradiates toward the light entering side 72 of the light guide plate 7.

Since the light source unit 2 of this invention has the advantage of shortening the light mixing distance, when used in a backlight module in practice, the distance from the light entering side 72 of the light guide plate 7 to the light source unit 2 can be shortened, thereby permitting a more compact design of the backlight module.

In sum, compared with the conventional light source unit, the light source unit of the present invention which has the LED chips 41, 42, 43 disposed directly on and connected electrically to the circuit substrate board 3 eliminates the use of package bases for carrying the LED chips in the prior art, thereby permitting a denser arrangement of the LED chips 41, 42, 43 on the circuit substrate board 3 to considerably reduce the LED chip spacing and to indirectly shorten the light mixing distance, thereby rendering miniaturization of the entire backlight module possible.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light source unit for use in a backlight module, comprising:
a circuit substrate board having a top face and a bottom face, and defining a first direction parallel to said top and bottom faces; and
a plurality of chip assemblies disposed directly on said top face of said circuit substrate board along the first direction and connected electrically to said circuit substrate board, each of said chip assemblies including a red light emitting diode chip, a blue light emitting diode chip, and a green light emitting diode chip.

2. The light source unit for use in a backlight module according to claim 1, further comprising an encapsulating member extending along a long-axis direction of said circuit substrate board to encapsulate said chip assemblies.

3. The light source unit for use in a backlight module according to claim 2, wherein said encapsulating member is formed by a mold forming method.

4. The light source unit for use in a backlight module according to claim 2, wherein said encapsulating member has a light guiding face extending along the long-axis direction of said circuit substrate board and disposed to converge dispersion angles of light emitted from said chip assemblies.

5. The light source unit for use in a backlight module according to claim 4, wherein said encapsulating member is formed by a mold forming method.

6. The light source unit for use in a backlight module according to claim 4, wherein said light guiding face is corrugated.

7. The light source unit for use in a backlight module according to claim 6, wherein said encapsulating member is formed by a mold forming method.

8. The light source unit for use in a backlight module according to claim 2, wherein said encapsulating member has a light guiding face that extends along the long-axis direction of said circuit substrate board and that is disposed to guide light emitted from said chip assemblies in a normal direction relative to the long-axis direction.

9. The light source unit for use in a backlight module according to claim 8, wherein said encapsulating member is formed by a mold forming method.

10. The light source unit for use in a backlight module according to claim 8, wherein said light guiding face is V-shaped.

11. The light source unit for use in a backlight module according to claim 10, wherein said encapsulating member is formed by a mold forming method.

12. The light source unit for use in a backlight module according to claim 1, wherein said chips of each of said chip assemblies are arranged in a straight line along a long-axis direction of said circuit substrate board in a color sequence of green, red and blue.

13. The light source unit for use in a backlight module according to claim 1, wherein said chips of each of said chip assemblies are arranged along a long-axis direction of said circuit substrate board and are arranged in a non-straight line.

14. The light source unit for use in a backlight module according to claim 1, wherein said chips of each of said chip assemblies are arranged along a short-axis direction of said circuit substrate board.

15. The light source unit for use in a backlight module according to claim 1, wherein each of said chips is formed with two electrodes thereon, at least one of said electrodes being connected electrically to said circuit substrate board by wire bonding.

16. The light-source unit for use in a backlight module according to claim 1, wherein said chips are connected electrically to said circuit substrate board by flip chip bonding.

17. The light source unit for use in a backlight module according to claim 1, further comprising a metal heat dissipating member provided on said bottom face of said circuit substrate board and corresponding to said circuit substrate board in shape.

18. The light source unit for use in a backlight module according to claim 17, wherein said metal heat dissipating member is formed from one of aluminum and copper.
